(19) United States
(12) Patent Application Publication
(10) Pub. No.: US 2018/0285846 A1
(43) Pub. Date: Oct. 4, 2018

(54) SYSTEM AND METHOD FOR PARKING VIOLATION RISK MANAGEMENT

(71) Applicant: GENERAL MOTORS LLC, Detroit, MI (US)

(72) Inventors: Christopher Oesterling, Troy, MI (US); Zafar Razzacki, Canton, MI (US); Leon Rawlings, Detroit, MI (US); Catherine Furlani, Birmingham, MI (US)

(21) Appl. No.: 15/477,364

(22) Filed: Apr. 3, 2017

(51) Int. Cl. G06Q 20/14

(52) U.S. Cl. CPC G06Q 20/145; G06Q 2240/00

(57) ABSTRACT

A system to manage parking violation risk including a memory, controller, vehicle, mobile computing device, and geocoded parking data module. The memory includes executable instructions. The controller can execute the instructions. The vehicle includes a vehicle system. The vehicle system can generate vehicle location data. The vehicle can also communicate the vehicle location data. The mobile computing device can receive transmissions. The geocoded parking data module can produce parking restriction data for a select location. Moreover, the executable instructions enable the controller to: receive a vehicle location transmitted after a vehicle event; perform the geocoded parking data module to identify parking restrictions at the vehicle location; generate a time restriction parameter based on the parking restrictions; monitor time after the first event; generate an expiration notification when the time duration is equal to the time restriction parameter value; and transmit the expiration notification to the mobile computing device.

### INTRODUCTION

Vehicle sharing and self-serve vehicle rental services allow customers to make reservations for station-based use of vehicles. These fleet vehicles are often located in reserved parking spots identified with mounted signs or markers. To gain vehicle access, consumers simply make a reservation through their mobile device. At the reservation beginning, the consumer need only be in proximity of the vehicle so that their mobile device can be activated as a virtual key and start their reservation.

Furthermore, consumers often reserve vehicles located in unfamiliar cities where parking restrictions are not fully understood. As a result, it is not uncommon for a consumer to receive a parking citation during their reservation. Such citations can understandably detract from the vehicle reservation experience, making it less enjoyable for the consumer. Accordingly, it is desirable to provide a system and method to foster a more seamless and enjoyable experience by notifying the consumer when their parked vehicle is at risk of receiving a parking violation.

### SUMMARY

A system to manage parking violation risk is presented herein. The system includes: a memory, controller, vehicle, mobile computing device, and geocoded parking data module. The memory is configured to include one or more executable instructions. The controller is configured to execute the executable instructions. The vehicle includes a vehicle system. The vehicle system is configured to generate vehicle location data. The vehicle is also configured to communicate the vehicle location data to the controller. The mobile computing device is configured to receive transmissions from the controller. The geocoded parking data module is configured to produce parking restriction data for a select location. Moreover, the executable instructions enable the controller to: receive a vehicle location transmitted from the vehicle after the occurrence of a vehicle event; perform the geocoded parking data module to identify one or more parking restrictions at the vehicle location; generate a time restriction parameter based on the one or more parking restrictions at the vehicle location; monitor the duration of time beginning from the first event occurrence time; generate an expiration notification when the time duration value becomes approximately equal to the time restriction parameter value; and transmit the expiration notification to the mobile computing device.

The vehicle event may be the vehicle ignition being turned to an OFF state. In one or more embodiments, the vehicle location may be considered a first vehicle location and the vehicle event may be considered a first vehicle event. In these embodiments, the executable instructions further enable the controller to: receive a second vehicle location from the vehicle after a second vehicle event; and cease monitoring the time duration based on the second vehicle location being substantially different than the first vehicle location. In another embodiment, the executable instructions can further enable the controller to delete the time restriction parameter based on the second vehicle location being substantially different than the first vehicle location. The second vehicle event may be the vehicle ignition being turned to an ON state.

In one or more embodiments, the memory is further configured to include one or more vehicle-share records. In this embodiment, the controller is further configured to communicate with the vehicle-share records. Moreover, the executable instructions further enable the controller to: store vehicle location data, time restriction parameter data, and expiration notification data in one or more of the vehicle-share records.

In one or more embodiments, the executable instructions further enable the controller to: generate a warning notification based on the time restriction parameter value and transmit that warning notification to the mobile computing device. The warning notification may also be configured to be generated fifteen (15) minutes before the time restriction parameter occurrence. The memory and controller may be located at a data center. The vehicle system may be a GPS component.

A method to manage parking violation risk is also presented herein. The method including the steps of: providing a memory configured to include one or more executable instructions; providing a controller configured to execute the executable instructions; providing a vehicle including a GPS component, the GPS component configured to generate vehicle location data, the vehicle configured to communicate the vehicle location data to the controller; providing a mobile computing device configured to communicate with the controller; providing a geocoded parking data module configured to produce parking restriction data for a select location; receiving (via the controller) a vehicle location transmitted from the vehicle after the occurrence of a vehicle event; performing (via the controller) the geocoded parking data module to identify one or more parking restrictions at the vehicle location; generating (via the controller) a time restriction parameter based on the one or more parking restrictions at the vehicle location; monitoring (via the controller) the duration of time beginning from the first event occurrence time; generating (via the controller) an expiration notification when the time duration value becomes approximately equal to the time restriction parameter value; and transmitting (via the controller) the expiration notification to the mobile computing device.

In one or more embodiments of the method, vehicle location is considered a first vehicle location and the vehicle event is considered a first vehicle event. In these embodiments, the method further includes the steps of: receiving (via the controller) a second vehicle location from the vehicle after the occurrence of a second vehicle event; and ceasing (via the controller) monitoring the time duration based on the second vehicle location being substantially different than the first vehicle location. In another embodiment, the method may further include the step of deleting (via the controller) the time restriction parameter based on the second vehicle location being substantially different than the first vehicle location.

In one or more embodiments, the memory is further configured to include one or more vehicle-share records. In these embodiments, the controller is further configured to communicate with the vehicle-share records. In these embodiment the method also includes the step of storing (via the controller) vehicle location data, time restriction parameter data, and expiration notification data in one or more of the vehicle-share records. In another embodiment, the method includes the steps of: generating (via the controller) a warning notification based on the time restriction parameter value; and transmitting (via the controller) the warning notification to the mobile computing device.

An additional method to manage parking violation risk is presented herein. This method including the steps of: providing a memory located at a data center, the memory is configured to include one or more executable instructions, the memory is further configured to include one or more vehicle-share records; providing a controller located at a data center, the controller is configured to execute the executable instructions, the controller is further configured to communicate with the vehicle-share records; providing a vehicle having a GPS component, the GPS component configured to generate vehicle location data, the vehicle configured to communicate the vehicle location data to the controller; providing a mobile computing device configured to communicate with the controller; providing a geocoded parking data module configured to produce parking restriction data for a select location; receiving (via the controller) a first vehicle location transmitted from the vehicle after the vehicle ignition has been turned to an OFF state; performing (via the controller) the geocoded parking data module to identify one or more parking restrictions at the vehicle location; generating (via the controller) a time restriction parameter based on the one or more parking restrictions at the vehicle location; storing (via the controller) vehicle location data, time restriction parameter data, and expiration notification data in one or more of the vehicle-share records; monitoring continuously (via the controller) the duration of time beginning from the time at which the vehicle ignition has been turned to an OFF state; determining (via the controller) whether the vehicle ignition has been turned to an ON state; determining (via the controller) whether a second vehicle location has been received from the vehicle after the vehicle ignition has been turned to an ON state; ceasing (via the controller) continuously monitoring the time duration only when it has been determined that the second vehicle location is substantially different than the first vehicle location and the vehicle ignition has been turned to an ON state; generating (via the controller) an expiration notification only when the time duration value becomes approximately equal to the time restriction parameter value; determining (via the controller) whether the time duration value has become approximately 15 minutes less than the time restriction parameter value; generating (via the controller) a warning notification only when it has been determined that the time duration value is approximately 15 minutes less than the time restriction parameter value; and transmitting (via the controller) to the mobile computing device the warning notification or expiration notification or both the warning notification and expiration notification.

The above features and advantages and other features and advantages of the present teachings are readily apparent from the following detailed description for carrying out the teachings when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is a block diagram depicting an exemplary embodiment of a communications system capable of utilizing the system and method disclosed herein;

FIG. 2 is a schematic representation of an exemplary geocoded parking data module according to an aspect of the system and method presented herein;

FIG. 3 is an exemplary system flow for utilization of the geocoded parking data module of FIG. 2.

FIG. 4 represents a map illustrating a performance of the geocoded parking data module of FIG. 2; and

FIG. 5 is a flow chart for an exemplary methodology for parking violation risk management.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present system and/or method. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The following detailed description is merely exemplary in nature and is not intended to limit the application and uses. Furthermore, there is no intention to be bound by any expressed or implied theory presented in the preceding background and brief summary or the following detailed description. As used herein, the term module refers to an application specific integrated circuit (ASIC), an electronic circuit, a processor (shared, dedicated, or group) and memory that executes one or more software or firmware programs or code segments, a combinational logic circuit, and/or other suitable components that provide the described functionality.

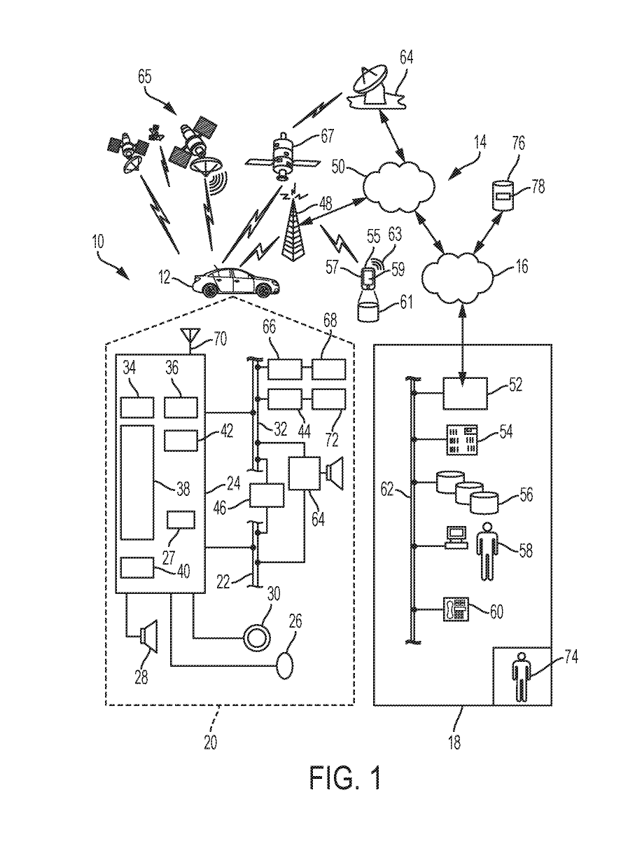

As shown in FIG. 1, there is shown a non-limiting example of a communication system 10 that may be used together with examples of the system disclosed herein and/or to implement examples of the methods disclosed herein. Communication system 10 generally includes a vehicle 12, a wireless carrier system 14, a land network 16, a data center 18 (i.e., the backend), and a module server 76. It should be appreciated that the overall architecture, setup and operation, as well as the individual components of the illustrated system are merely exemplary and that differently configured communication systems may also be utilized to implement the examples of the system and/or method disclosed herein. Thus, the following paragraphs, which provide a brief overview of the illustrated communication system 10, are not intended to be limiting.

Vehicle 12 may be any type of manually operated or autonomous vehicle such as a motorcycle, car, truck, recreational vehicle (RV), bicycle, boat, plane, etc., and is equipped with suitable hardware and software that enables it to communicate over communication system 10. Some of the fundamental vehicle hardware 20 is shown generally in FIG. 1 including a telematics unit 24, a microphone 26, a speaker 28, and buttons and/or controls 30 connected to telematics unit 24. Operatively coupled to telematics unit 24 is a network connection or vehicle bus 32. Examples of suitable network connections include a controller area network (CAN), a media oriented system transfer (MOST), a local interconnection network (LIN), an Ethernet, dedicated short-range communications (DSRC) channel, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is a communication system which provides a variety of services through its communications with the data center 18, and generally includes an electronic processing device 38, one or more types of electronic memory 40, a cellular chipset/component 34, a wireless modem 36, a dual mode antenna 70, and a navigation unit containing a GPS component 42 capable of communicating location data via a GPS satellite system. GPS component 42 thus receives coordinate signals from a constellation of GPS satellites 65. From these signals, the GPS component 42 can determine vehicle position, which may be used for providing navigation and other position-related services to the vehicle operator. Navigation information can be presented on a display of telematics unit 24 (or other display within the vehicle) or can be presented verbally such as is done when supplying turn-by-turn navigation. The navigation services can be provided using a dedicated in-vehicle navigation module (which can be part of GPS component 42), or some or all navigation services can be done via telematics unit 24, wherein the location coordinate data is sent to a remote location (e.g., data center 18) for purposes of providing the vehicle with navigation maps, map annotations, route calculations, and the like.

The telematics unit 24 may provide various services including: turn-by-turn directions and other navigation-related services provided in conjunction with the GPS chipset/component 42 (e.g., nearby parking restriction information); airbag deployment notification and other emergency or roadside assistance-related services provided in connection with various crash and/or collision sensor interface modules 66 and collision sensors 68 located throughout the vehicle and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services telematics unit 24 may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and the wireless modem 36 for data transmission. Any suitable encoding or modulation technique may be used with the present examples, including digital transmission technologies, such as TDMA (time division multiple access), CDMA (code division multiple access), W-CDMA (wideband CDMA), FDMA (frequency division multiple access), OFDMA (orthogonal frequency division multiple access), etc. To accomplish this effect, dual mode antenna 70 services the GPS component 42 and the cellular chipset/component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and data center 18 to communicate with the occupants through audible speech. The vehicle hardware also includes one or more buttons and/or controls 30 for enabling a vehicle occupant to activate or engage one or more of the vehicle hardware components 20. For example, one of the buttons and/or controls 30 can be an electronic pushbutton used to initiate voice communication with data center 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to telematics unit 30 via the crash and/or collision detection sensor interface 66 regarding the severity of a vehicle collision, such as the angle of impact and the amount of force sustained.

Vehicle sensors 72, connected to various vehicle sensor modules 44 (VSMs) in the form of electronic hardware components located throughout vehicle 12 and use the sensed input to perform diagnostic, monitoring, control, reporting and/or other functions. Each of the VSMs 44 is preferably connected by vehicle bus 32 to the other VSMs, as well as to the telematics unit 24, and can be programmed to run vehicle system and subsystem diagnostic tests. As examples, one VSM 44 can be an engine control module (ECM) that controls various aspects of engine operation such as fuel ignition and ignition timing. According to one embodiment, the ECM is equipped with on-board diagnostic (OBD) features that provide myriad real-time data, such as that received from various sensors including vehicle emissions sensors, fuel diagnostics sensors, and vehicle oil pressure sensors as well as provide a standardized series of diagnostic trouble codes (DTCs) which allow a technician to rapidly identify and remedy malfunctions within the vehicle. VSM 44 can similarly be a powertrain control module (PCM) that regulates operation of one or more components of the powertrain system. Another VSM 44 can be a body control module (BCM) that monitors and governs various electrical components located throughout the vehicle body like the vehicle's power door locks, air conditioner, tire pressure, lighting system, engine ignition, vehicle seat adjustment and heating, mirrors, and headlights. Furthermore, as can be appreciated by skilled artisans, the above-mentioned VSMs are only examples of some of the modules that may be used in vehicle 12, as numerous others are also possible.

A passive entry passive start (PEPS) module, for instance, is another of the numerous of VSMs and provides passive detection of the absence or presence of a passive physical key or a virtual vehicle key. When the passive physical key approaches, the PEPS module can determine if the passive physical key is authentic as belonging to the vehicle 12. The PEPS can likewise use authentication information received from data center 18 to determine if a mobile computing device 57 with virtual vehicle key is authorized/authentic to vehicle 12. If the virtual vehicle key is deemed authentic, the PEPS can send a command to BCM 44 permitting access to the vehicle 12. The PEPS can also provide passive entry health information to ensure sufficient module functionality for the passive physical key or virtual vehicle key operations. It should be understood that the PEPS may be an electronic hardware component connected to the vehicle bus 32 or, in an alternative embodiment, may be one or more software code segments uploaded to electronic memory 40.

Wireless carrier system 14 may be a cellular telephone system or any other suitable wireless system that transmits signals between the vehicle hardware 20 and land network 16. According to an example, wireless carrier system 14 includes one or more cell towers 48.

Land network 16 can be a conventional land-based telecommunications network connected to one or more landline telephones, and that connects wireless carrier system 14 to data center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

As revealed above, one of the networked devices that can directly or indirectly communicate with the telematics unit 24 is a mobile computing device 57, such as (but not limited to) a smart phone, personal laptop computer or tablet computer having two-way communication capabilities, a wearable computer such as (but not limited to) a smart watch or glasses, or any suitable combinations thereof. The mobile computing device 57 can include computer processing capability, a transceiver 53 capable of communicating with remote locations such as, for example, data center 18 via wireless carrier system 14, a user interface 59, and/or a GPS module 63 capable of receiving GPS satellite signals and generating GPS coordinates based on those signals. User interface 59 may be embodied as a touch-screen graphical interface capable of user interaction as well as exhibiting information. Examples of the mobile computing device 57 include the iPhone™ and Apple Watch™ each being manufactured by Apple, Inc. and the Droid™ smart phone manufactured by Motorola, Inc. as well as others.

Mobile device 57 may be used inside or outside of a vehicle, and may be coupled to the vehicle by wire or wirelessly. Mobile device 57 may also be configured to provide services according to a subscription agreement with a third-party facility or wireless/telephone service provider. It should be appreciated that various service providers may utilize the wireless carrier system 14 and that the service provider of telematics unit 30 may not necessarily be the same as the service provider of mobile device 57.

When using a short-range wireless connection (SRWC) protocol (e.g., Bluetooth Low Energy, Wi-Fi, etc.), mobile computing device 57 and telematics unit 24 may pair with each other (or link to one another) on a case-by-case basis and while within a wireless range; SRWC pairing is known to skilled artisans. The SRWC protocol may be an aspect of telematics unit 24 or may be part of one or more independent VSMs 44 such as the PEPS and/or BCM 44. Once SRWC is established, the devices may be considered bonded (i.e., they may recognize one another and/or connect automatically when they are in a predetermined proximity or range of one other. In other words—they may become, at least temporarily, network participants).

This unique pairing, for example, allows mobile computing device 57 to act as the virtual key fob briefly mentioned above. To illustrate for this to happen—upon receiving a request, data center 18 will generate an encrypted virtual vehicle key to permit vehicle access via mobile computing device 57. Data center 18 will then transmit aspects this encrypted virtual vehicle key information to both mobile computing device 57 and the PEPS module 44 via telematics unit 24. After paring has been established, mobile computing device 57 will send its virtual vehicle key aspect to telematics unit 24 for recognition in light of its stored corresponding virtual key aspect and in turn the PEPS module may establish mobile computing device 57 as the key fob for vehicle 12. Data center 18 may also transmit one or more time parameters with the encrypted virtual vehicle key information so as to temporarily establish the virtual vehicle key of mobile device 57.

Data center 18 is designed to provide the vehicle hardware 20 with a number of different system backend functions and, according to the example shown here, generally includes one or more switches 52, servers 54, databases 56, advisors 58, city managers 74, as well as a variety of other telecommunication/computer equipment 60. These various data center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58 or an automated response system, and data transmissions are passed on to a modem or other piece of telecommunication/computer equipment 60 for demodulation and further signal processing. The modem or other telecommunication/computer equipment 60 may include an encoder, as previously explained, and can be connected to various devices such as a server 54 and database 56.

Server 54 can incorporate a data controller which essentially controls the operations of server 54. Server 54 may control data information as well as act as a transceiver to send and/or receive the data information (i.e., data transmissions) from one or more of the data bases 54, telematics unit 24, and mobile computing device 57. The controller is moreover capable of reading executable instructions stored in a non-transitory machine readable medium and may include one or more from among a processor, a microprocessor, a central processing unit (CPU), a graphics processor, Application Specific Integrated Circuits (ASICs), Field-Programmable Gate Arrays (FPGAs), state machines, and a combination of hardware, software and firmware components.

The city manager 74 may be delegated assignments by data center 18 and may be remotely located therefrom. The responsibilities of city manager 74 include oversight of fleet rotation, vehicle system malfunction/damage assessment, and dealing with various customer-related situations. For example, data center 18 will notify city manager 74 when a fleet vehicle malfunctions and city manager 74 will arrive at the scene to assess the vehicle to determine the specific malfunction type.

Database 56 could be designed to store numerous vehicle-share services records (i.e., vehicle reservation information) having information related to the vehicle such as, but not limited to, vehicle-share vehicle records (e.g., vehicle VSM information, vehicle identification information, vehicle system verification information/alerts, vehicle anomaly information), information related to the user such as, but not limited to, reservation account records (e.g., vehicle comfort settings information, telematics unit settings, vehicle make-model preferences, driving record information, parking history information, etc.), and information related to organizing vehicle reservations as well as fleet management such as, but not limited to, reservation profile records (e.g., reservation calendar information, vehicle assignment information, parking information, third party contact information, etc.); or any other pertinent vehicle-share system information (system usage statistics information, etc.). This stored backend information could moreover be written in SQL. In certain instances, this vehicle-share services records information may be accessible to the user, data center 18, or one or more third parties (e.g., city manager 74) as well as be copied, organized, and/or stored in a tabular form to allow continuous and real-time updates. The vehicle-share records can additionally collaborate with a reservation account (discussed below) for support of, for example, reservation management and fleet management.

The user of mobile computing device 57 may create their own personalized vehicle reservation account to be stored in mobile memory 61 and which may have access to the vehicle-share records at the backend. The user may perform tasks to create this account through a variety of frontend devices such, for example, as through a remote computer and mobile computing device 57. This reservation account may be uploaded to or accessible on server 54 (i.e., to support backend functions). Data center 20 may also access one or more additional remote servers and/or remote databases (e.g., Department of Motor Vehicles, weather databases, traffic databases, etc.) to receive information in support of the reservation account as well as a particular reservation and one or more vehicle-share services records.

The reservation account may include validating data to verify and/or validate that future login attempts are secure (e.g., granting access only to the user). The validating data may include an account username and account password as well as user information (e.g., driver's license information), mobile computing device information such as, for example, the unique mobile device identifier (i.e., serial number). The user account may additionally store a variety of user preferences.

The user of mobile device 57 may visit an online software application store or web-service and download the reservation account therefrom. The reservation account may moreover include one or more prompts to instruct the user to provide information (e.g., validating data) to support account creation. Reservation account may be configured to assist a vehicle-share system user in reserving a fleet vehicle by operatively accessing and communicating with the backend vehicle-share services records.

Although the illustrated example has been described as it would be used in conjunction with a manned data center 18, it will be appreciated that the data center 18 can be any central or remote facility, manned or unmanned, mobile or fixed, to or from which it is desirable to exchange voice and data.

Module server 76 can be one of a number of computers accessible via a private or public network such as the Internet. Each such computer 76 can be used for one or more purposes, such as processing a geocoded parking data module 78 configured to produce parking restriction data at one or more selected locations (discussed below). Other such accessible computers 18 can be, for example a third party repository to or from which vehicle data or other information is provided, whether by communicating with the vehicle 12 or data center 20, or both.

### Geocoded Parking Data Module

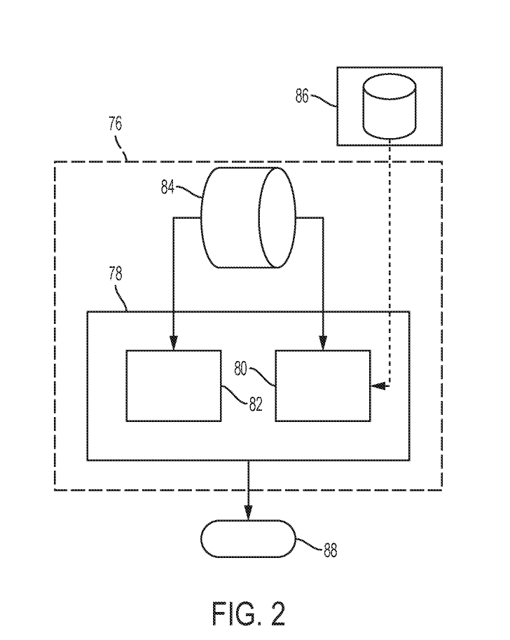

FIG. 2 is a block diagram schematically showing a detailed exemplary embodiment of module server 76 as including certain functional blocks, which do not necessarily correspond to any physical separation of the functions. Rather, these blocks correspond to software modules (code segments). Geocoded parking data module 78 may be performed to identify at least one targeted parking restriction (e.g., unauthorized parking violation rules) at a specific location, as discussed above.

Geocoded parking data module 78 includes two distinct components—a mapping engine 80 and search engine 82. Mapping engine 80 receives and serves map requests from and on behalf of data center server 54. For example, in response to a request to provide a map of given GPS coordinates, mapping engine 80 retrieves the required information from information storage 84, and then filters and formats the map data in suitable form for provision to data center server 54. Conversely, search engine 80 receives and serves requests from the data center server 54 to locate a certain geographical feature for the map such as, but not limited to, a city, street, parking restrictions, building addresses and Point of Interest information. Module server 76 may correspondingly use data from a third-party service provider 86 to support production of a map data output 88. For example, search engine 80 may access a third-party geocode database and parking authority database in order to determine geocodes (map coordinates) of given cities, streets, parking restrictions, and other geographical features. Moreover, third-party service provider 86 may include one or more dynamic content providers. Geocoded data module 78 may generate map data in the form of text labels. The output of data module 78 may be compressed into a binary form, to minimize the bandwidth consumed by transmission of the data from module server 78 to data center server 54. This transmitted data may further be encrypted for purposes of data security.

The map data output 88 may be arranged in layers, each layer corresponding to a different type of map feature, as is generally known. The layers define the shapes and locations of the features and can include textual labels. One or more of these layers may additionally include dynamic data, such as traffic conditions. In those embodiments of which the map data output 88 includes a visualization aspect (e.g., to be exhibited via display 59 of mobile computing device 57), module server 76 holds multiple templates for each layer, and can download the appropriate templates to data center server 54. Skilled artisans will also see that the collection of templates used to render multiple layers on a given client device may be treated as a single multi-template. Since the same templates are used in displaying maps of different geographical areas, data center server 54 may store the templates in databases 56, so that the templates need be downloaded only once to display multiple different maps.

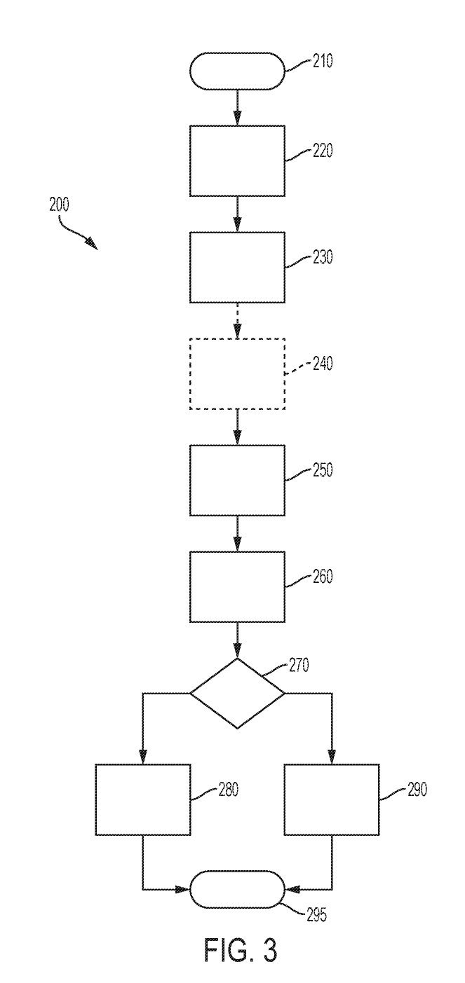

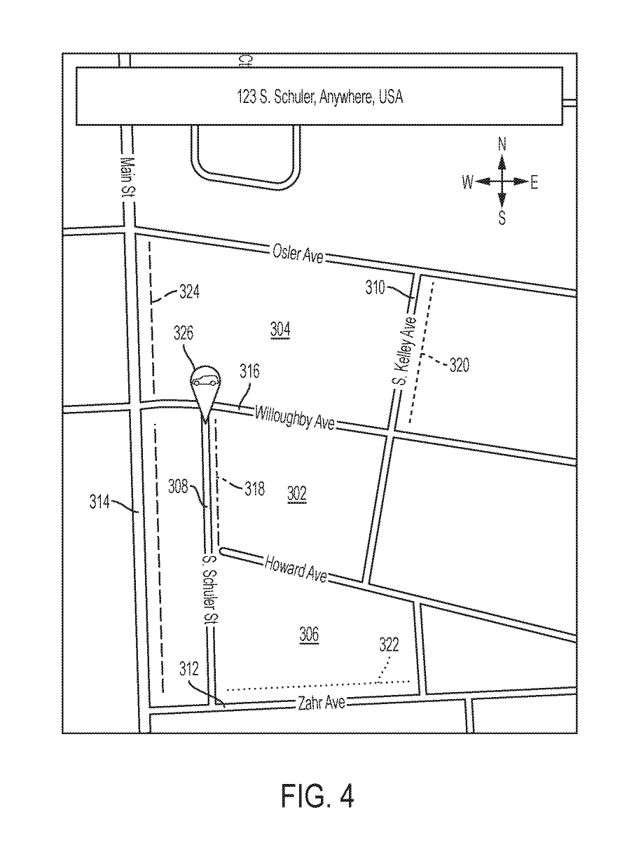

FIG. 3, and with further reference to FIG. 4, shows an exemplary schematic representation of an embodiment a system flow for the discussed above parking data module 78. As illustrated in FIG. 2, system flow 200 starts with transmitted location data 210 arriving at module server 76; this location data includes tracked, demodulated GPS coordinates that have been generated from GPS component 42. In step 220, data module 78 receives the location data and subsequently provides the data as a map request to mapping engine 80. Mapping engine 80 retrieves the required information from information storage 84, and then filters and formats the map data in a suitable form, in step 230. In step 240, search engine 82 locates and retrieves certain geographical features for this map data. Search engine 82 may additionally correspond with a third-party service provider 86 to receive more accurate map data (e.g., dynamic data) and subsequently compile and analyze this third party data, in optional step 240. In step 250, data module 78 combines the data processed, compiled, and received from mapping engine 80 and search engine 82 to construct the map data as an accurate parking restriction map 300.

As illustrated, map 300 includes: city block A 302, city block B 304, and city block C 306. Map 300 further includes street A 308, street B 310, street C 312, and street D 314. Map 300 also includes parking restriction A 318, parking restriction B 320, parking restriction C 322, and parking restriction D 324. As shown, each parking restriction is laid over a portion of the corresponding block to designate the unique parking restriction along one side of the corresponding street. For example, street A 308 may include parking restriction A 318 which allows a vehicle to be parked at any point along the western side of city block A 302 for a maximum of two (2:00:00) hours. Additionally, in this example, street B 310 may include parking restriction B 320 which allows a vehicle to be parked at any point across the street from the eastern side of city block B 304 at those times which fall between 11:00:00 PM and 8:00:00 AM. Street C 312 may include parking restriction C 322 which allows a vehicle to be parked at any point along the southern side of city block C 306 for a maximum of twelve (12:00:00) hours. Alternatively, street D may be a highway having a parking restriction D which completely restricts vehicles from parking anywhere along its eastern side, such as the western side of city block B 304. Furthermore, as shown, the map request input places a vehicle location 326 at the western side of city block A 302 and under the two (2:00:00) hour maximum of parking restriction A 318.

Upon completion of parking restriction map 300, in step 270, data module 78 determines if the input places the vehicle location 326 under one or more parking restrictions. If the vehicle location 326 reflects restrictions are applied to this location, then system flow 200 moves to step 280; otherwise, when no restrictions apply, system flow 200 moves to step 290. In step 280, data module 78 will provide to data center 18 the identified parking restrictions at vehicle location 326 in a proper data format (binary code format). Skilled artisans will see that this data may further include a visualization aspect to allow the data to be exhibited on a display such as, but not limited to, the mobile device user interface 59 and/or the display of telematics unit 24. In step 290, data module 78 will provide a non-restrictive location notification (e.g., text data) to data center 18 that signifies no parking restrictions could be found for the vehicle location. After step 280 or 290, the system flow 200 ends and finalizes its operations 295.

### Method

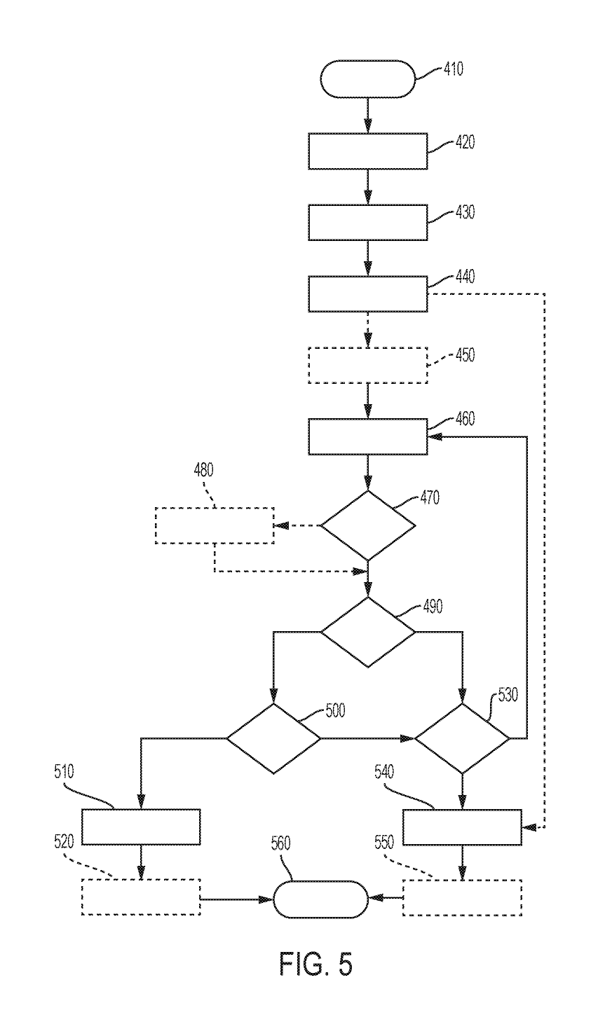

Turning now to FIG. 5, there can be seen an application of an exemplary method 400 to generate parking restriction information through parking restriction data module 78 and provides such restriction information to manage the risk of receiving a parking violation. Aspects of this method are executed through the backend controller 52, for example, implementing the functionality of the part of data module 78 stored at module server 76. Peripheral aspects may additionally be executed through mobile computing device 57, for example, implementing the frontend functionality of exhibiting an expiration notification and optional warning notification via user interface 59.

In this method, telematics unit 24 is preconfigured to recognize certain vehicle events and in turn transmit location data from GPS component 42 as well as vehicle identification information (e.g., VIN number) automatically after such vehicle events. Method 300 begins with the event of the vehicle ignition being turned to an OFF state at 410 (i.e., the vehicle being powered down). This event 410 may likewise be the vehicle transition being shifted to the PARK gear, or the parking brake being activated, for some duration of time (e.g., ten (10) minutes).

Upon an occurrence of the vehicle event, in step 420, vehicle 12 will automatically transmit the location data to data center server 54 and may also transmit the vehicle identification information. What is more, in this step, server 54 will receive the transmitted vehicle identification information and vehicle location data as well as track and demodulate the corresponding GPS coordinates into a suitable form for parking restriction data module 78. Data center server 54 transmits the location data to module server 76 via the wireless carrier system 14, in step 430. Parking restriction data module 78 is then performed to produce the identified parking restrictions data (or the non-restrictive location notification), as discussed above. This identified parking restrictions data is consequently transmitted back to server 54. Additionally, in this step, server 54 may use the vehicle identification information to locate the vehicle-share records corresponding to, for example, the current reservation information for vehicle 12.

Server 54 will then review and analyze the parking restrictions data and, if needed, derive a time restriction parameter, in step 440. From the above example, when parking restriction A 318 governs the vehicle location 324, the time restriction parameter would be two (2:00:00) hours or 120:00 minutes from the vehicle being turned to an OFF state (step 410). Thus, if the vehicle ignition was turned OFF at 3:00:00 PM, then the time restriction parameter would be 120:00 minutes from that time (i.e., 5:00:00 PM). If, for some reason, a substantial amount of time passes between the vehicle ignition being turned to an OFF state (step 410) and server 54 receiving the parking restriction data (step 430), then server 54 may subtract that amount of passed time from the time restriction parameter. Using the same example, if it has taken two (2:00) minutes for server 54 to receive the data, the time restriction parameter may be adjusted to 118:00 minutes to correct this deficiency. Therefore, this will allow the time restriction parameter to remain 120:00 minutes from the time of the vehicle ignition being turned OFF.

Additionally, similarly, from the above example, when parking restriction B 318 governs the vehicle location 324 (i.e., those times which fail between 11:00:00 PM and 8:00:00 AM), server 54 would first be required to correspond with one or more generally known and simple clock programs to determine the current time before being able to derive the time restriction parameter. Thus, if server 54 establishes that it is 1:00:00 AM via the clock program, then the derived time restriction parameter would be 420:00 minutes (i.e., 8:00:00 AM). In addition, on the other hand, if server 54 establishes that it is 4:00:00 PM via the clock program, then the derived time restriction parameter would be 0:00 minutes to reflect that the vehicle is restricted from parking at this time. In such an instance, when the time restriction parameter has no remaining time what-so-ever, method 400 will skip directly to step 540, as discussed below.

If there are no established parking restrictions (i.e., server 54 receives a non-restriction location notification), then method 400 will skip to process completion 560. Sever 54 may also, in this step, optionally generate a support parameter that is set to occur at some time duration prior to the time restriction parameter (e.g., fifteen (15:00) minutes). (In the exemplary time of 1:00:00 AM, using the above logic, the support parameter of 15:00 minutes would be set for 405:00 minutes.)

Server 54 may also store the time restriction parameter and the vehicle location data to one or more vehicle-share records (e.g., driving record information, parking history information, etc.) in database 56, in optional step 450. Uploading this data to the vehicle-share records facilitates the production of statistics regarding vehicle-share system usage. It also provides a more complete driving record for each reservation account user. It can further allow city manager 74 access to the uploaded data for resource allocation management purposes.

Server 54 will then begin to continuously or periodically (e.g., every ten (10) seconds) monitor the lapse of time in relation to the ignition being turned to an OFF state (step 410), in step 460. This may be conducted through the simple clock programs that has been stored in database 56, embedded within the controller of server 54, or transmitted from some remote location (e.g., module server 76). In optional step 470, sever 54 will determine if the elapsed time has reached (become equal to) the support parameter. As such, for example, if it is reflected that the current time is 4:40:34 PM, then the elapsed time remains to be less than a support parameter time set at 4:45:00 PM and method 400 will move to step 490. However, if it is reflected that the current time is 4:45:00 PM, then the elapsed time has become equal to the support parameter time of 4:45:00 PM and method 400 will move to optional step 480.

In optional step 480, subsequently, server 54 will generate a warning notification (e.g., text message) and wirelessly transmit the warning notification to mobile computing device 57. This warning notification may provide the mobile device user to understand they have fifteen (15:00) minutes to remove their vehicle from its current location or else they risk receiving a parking citation for being in violation of the local parking restriction. Server 54 may also be configured to subsequently generate and transmit similar warning notifications after the first notification. For example, an additional warning notification could be established to be transmitted ten (10:00) minutes after the original warning notification.

After occurrence of this optional warning notification, in step 490, server 54 determines whether the vehicle ignition has been turned to an ON state (i.e., has the user restarted the vehicle engine), to create the occurrence of a second vehicle event. As follows, if server 54 determines that the vehicle ignition has been turned to an ON state, method 400 will move to step 500; otherwise, method 400 will move to step 530. In step 500, server 54 subsequently determines if it has received newfangled second vehicle location data from telematics unit 24. Server 54 will also demodulate the GPS coordinates to see if such coordinates of the second vehicle location reflect that the vehicle has moved a substantial distance from its originally determined location (e.g., 15 yards). In this step, if server 54 determines that it has received second vehicle location data which reflects the vehicle is now located at a substantially different location than the original vehicle location, method 400 will move to step 510; otherwise, method 400 will move to step 530.

Upon receiving the substantial second vehicle location data, in step 510, server 54 will cease monitoring the time lapse which began when the vehicle ignition was turned OFF (discussed in step 410). As such, server 54 will generally shut down the clock program being used to count this time. In optional step 520, server 54 may also delete the stored time restriction parameter from one or more vehicle-share records, in an effort to conserve memory space in database 56. Upon completion of optional step 520 (or step 510, when appropriate), method 400 will move to the process completion 560.

Moving over to step 530, server 54 determines if the value of the time duration has reached the same value as the time restriction parameter. For example, if the time duration value reflects that the current time is 4:58:59, then this value has not reached the time restriction parameter of 5:00:00. In this instance, method 400 will return to step 460 so as to monitor the time lapse. However, for example, if both the time duration value and time restriction value reflect an equivalent value of 5:00:00, then method 400 will move to step 540.

In step 540, server 54 generates an expiration notification (e.g., text message) and wirelessly transmits that expiration notification to mobile computing device 57. This expiration notification may provide the mobile device user to understand they are now required to move their vehicle from its current location or else they risk receiving a parking citation for being in violation of the local parking restriction. Server 54 may also be configured to subsequently generate and automatically transmit similar expiration notifications after this expiration notification. For example, an additional expiration notification could be established to be transmitted five (5:00) minutes after the original expiration notification to ensure the user gets the point. In optional step 550, server 54 may also store expiration notification data to one or more vehicle-share records (e.g., driving record information and parking history information) in database 56. As explained above, uploading this data to the vehicle-share records facilitates the production of statistics regarding vehicle-share system usage. It also provides a more complete driving record for each reservation account user. Upon completion of optional step 550 (or step 520, when appropriate), method 400 will move to the process completion 560.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the system and/or method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system to manage parking violation risk, the system comprising:
a memory configured to comprise one or more executable instructions;
a controller configured to execute the executable instructions;
a vehicle comprising a vehicle system, the vehicle system configured to generate vehicle location data, the vehicle configured to communicate the vehicle location data to the controller;
a mobile computing device configured to receive transmissions from the controller;
a geocoded parking data module configured to produce parking restriction data for a select location;
wherein the executable instructions enable the controller to:
receive a vehicle location transmitted from the vehicle after the occurrence of a vehicle event;
perform the geocoded parking data module to identify one or more parking restrictions at the vehicle location;
generate a time restriction parameter based on the one or more parking restrictions at the vehicle location;
monitor the duration of time beginning from the first event occurrence time;
generate an expiration notification when the time duration value becomes approximately equal to the time restriction parameter value; and
transmit the expiration notification to the mobile computing device.

2. The system of claim 1, wherein the vehicle event is the vehicle ignition being turned to an OFF state.

3. The system of claim 1, wherein:
the vehicle location is considered a first vehicle location and the vehicle event is considered a first vehicle event;
the executable instructions further enable the controller to:
receive a second vehicle location from the vehicle after a second vehicle event; and
cease monitoring the time duration based on the second vehicle location being substantially different than the first vehicle location.

4. The system of claim 3, wherein the executable instructions further enable the controller to delete the time restriction parameter based on the second vehicle location being substantially different than the first vehicle location.

5. The system of claim 3, wherein the second vehicle event is the vehicle ignition being turned to an ON state.

6. The system of claim 1, wherein:
the memory further configured to comprise one or more vehicle-share records;
the controller further configured to communicate with the vehicle-share records;
the executable instructions further enable the controller to:
store vehicle location data, time restriction parameter data, and expiration notification data in one or more of the vehicle-share records.

7. The system of claim 1, wherein the executable instructions further enable the controller to:
generate a warning notification based on the time restriction parameter value; and
transmit the warning notification to the mobile computing device.

8. The system of claim 7, wherein the warning notification is configured to be generated 15 minutes before the time restriction parameter occurrence.

9. The system of claim 1, wherein the memory and controller are located at a data center.

10. The system of claim 1, wherein the vehicle system is a GPS component.

11. A method to manage parking violation risk, the method comprising:
providing a memory configured to comprise one or more executable instructions;
providing a controller configured to execute the executable instructions;
providing a vehicle comprising a GPS component, the GPS component configured to generate vehicle location data, the vehicle configured to communicate the vehicle location data to the controller;
providing a mobile computing device configured to communicate with the controller;
providing a geocoded parking data module configured to produce parking restriction data for a select location;
receiving, via the controller, a vehicle location transmitted from the vehicle after the occurrence of a vehicle event;
performing, via the controller, the geocoded parking data module to identify one or more parking restrictions at the vehicle location;
generating, via the controller, a time restriction parameter based on the one or more parking restrictions at the vehicle location;
monitoring, via the controller, the duration of time beginning from the first event occurrence time;
generating, via the controller, an expiration notification when the time duration value becomes approximately equal to the time restriction parameter value; and
transmitting, via the controller, the expiration notification to the mobile computing device.

12. The method of claim 11, wherein the vehicle event is the vehicle ignition being turned to an OFF state.

13. The method of claim 11, further comprising:
wherein the vehicle location is considered a first vehicle location and the vehicle event is considered a first vehicle event;
receiving, via the controller, a second vehicle location from the vehicle after the occurrence of a second vehicle event; and
ceasing, via the controller, monitoring the time duration based on the second vehicle location being substantially different than the first vehicle location.

14. The method of claim 13, further comprising the step of deleting, via the controller, the time restriction parameter based on the second vehicle location being substantially different than the first vehicle location.

15. The method of claim 13, wherein the second vehicle event is the vehicle ignition being turned to an ON state.

16. The method of claim 11, further comprising:
wherein the memory further configured to comprise one or more vehicle-share records;
wherein the controller further configured to communicate with the vehicle-share records; and
storing, via the controller, vehicle location data, time restriction parameter data, and expiration notification data in one or more of the vehicle-share records.

17. The method of claim 11, further comprising:
generating, via the controller, a warning notification based on the time restriction parameter value; and
transmitting, via the controller, the warning notification to the mobile computing device.

18. The method of claim 17, wherein the warning notification is configured to be generated 15 minutes before the time restriction parameter occurrence.

19. The method of claim 11, wherein the memory and controller are located at a data center.

20. A method to manage parking violation risk, the method comprising:
providing a memory located at a data center, the memory configured to comprise one or more executable instructions, the memory further configured to comprise one or more vehicle-share records;
providing a controller located at a data center, the controller configured to execute the executable instructions, the controller further configured to communicate with the vehicle-share records;
providing a vehicle comprising a GPS component, the GPS component configured to generate vehicle location data, the vehicle configured to communicate the vehicle location data to the controller;
providing a mobile computing device configured to communicate with the controller;
providing a geocoded parking data module configured to produce parking restriction data for a select location;
receiving, via the controller, a first vehicle location transmitted from the vehicle after the vehicle ignition has been turned to an OFF state;
performing, via the controller, the geocoded parking data module to identify one or more parking restrictions at the vehicle location;
generating, via the controller, a time restriction parameter based on the one or more parking restrictions at the vehicle location;
storing, via the controller, vehicle location data, time restriction parameter data, and expiration notification data in one or more of the vehicle-share records;
monitoring continuously, via the controller, the duration of time beginning from the time at which the vehicle ignition has been turned to an OFF state;
determining, via the controller, whether the vehicle ignition has been turned to an ON state;
determining, via the controller, whether a second vehicle location has been received from the vehicle after the vehicle ignition has been turned to an ON state;
ceasing, via the controller, continuously monitoring the time duration only when it has been determined that the second vehicle location is substantially different than the first vehicle location;
determining, via the controller, whether the time duration value has become approximately 15 minutes less than the time restriction parameter value;
generating, via the controller, a warning notification only when it has been determined that the time duration value is approximately 15 minutes less than the time restriction parameter value; and
generating, via the controller, an expiration notification only when the time duration value becomes approximately equal to the time restriction parameter value;
transmitting, via the controller, to the mobile computing device the warning notification or expiration notification or both the warning notification and expiration notification.
